(19) United States
(12) Patent Application Publication
(10) Pub. No.: US 2020/0218231 A1
(43) Pub. Date: Jul. 9, 2020

(54) SYSTEM FOR VEHICLE BODY CONSTRUCTION

(71) Applicant: DESTACO EUROPE GMBH, Oberursel (DE)

(72) Inventor: Christian SCHUBERT, Oberursel (DE)

(73) Assignee: DE-STA-CO Europe GmbH, Oberursel (DE)

(21) Appl. No.: 16/649,348

(22) PCT Filed: Sep. 20, 2018
(86) PCT No.: PCT/DE2018/100800

§ 371 Date: Mar. 20, 2020

(30) Foreign Application Priority Data
Sep. 21, 2017 (DE) 10 2017 121 886.6

(51) Int. Cl. G05B 19/4097; G05B 19/4063

(52) U.S. Cl. CPC G05B 19/4097; G05B 2219/45018; G05B 19/4063

(57) ABSTRACT

The invention relates to a system for vehicle body construction, comprising a central control unit (1) and at least two electrically operated actuation devices (2), which each have their own control unit (2.1) for controlling the movement of said actuation devices. According to the invention, the control unit (2.1) of one of the two actuation devices (2) is connected to the central control unit (1) via the control unit (2.1) of the other of the two actuation devices (2).

### CROSS-REFERENCE TO RELATED APPLICATIONS

This application is a National Stage of International Application No. PCT/de2018/100800, filed Sep. 20, 2018. The entire disclosure of the above application is incorporated herein by reference.

### FIELD

The disclosure relates to a system for vehicle body construction.

### DISCLOSURE

A system for vehicle body construction of the above-mentioned type is known in principle from document DE 201 21 630 U1. This system has a central control unit (referred to as higher ranking control unit), that is typically accommodated in a control cabinet. An electrically operated operating device (referred to as clamping device), has its own control unit to control its movement. Even though it is not mentioned explicitly in the document, a person of skill in the art does know that, in addition to the central control unit, such a system always has a plurality (thus of at least two) of such operating devices. The devices are each directly connected to the central control unit. In automobile construction, such a system is used, for example, when welding together the individual vehicle body parts. An operating device shall hereinafter, in general, be understood to be a clamping, a pivoting, a centering or also a positioning device or the like.

### SUMMARY

The disclosure is based on the object of improving a system for vehicle construction of the above-mentioned type. In particular, a system for vehicle construction where a reduced cabling effort is created.

The object is solved with a system of the above-mentioned, comprising a central control unit and at least two electrically operated operating devices. Each device has its own control unit to control movement. The control unit of one of the two operating devices is connected to the central control unit via the control unit of the other one of the two operating devices.

According to the disclosure the control unit of one of the two operating devices is embodied so as to be connected to the central control unit, via the control unit of the other one of the two operating devices.

In other words, the solution according to the disclosure comprises a control unit of a first control device directly connected to the central control unit. At least one control unit of a second operating device is now no longer directly connected to the central control unit, but only indirectly, via the control unit of the first operating device. Not every control unit of the operating device of the system is thus still directly connected to the central control unit. In fact, it is possible to only directly connect a first control unit of a first operating device to the central control unit. A second control unit of a second operating device is only connected to the first control unit of the first operating device. It receives, from the latter, the signals arriving from the central control unit. Thus, the signals arriving from the central control unit are looped through from one to the next operating device. In a particularly preferred manner, a large number of operating devices are connected in series. This is advantageous since it provides a significant reduction of the cabling effort.

In all of this, in a particularly preferred manner, the control units of the operating devices are data processing units. The units send, receive and process data packets. In other words, the operating devices are each provided with their own, complete computer. The computer completely takes over the regulation of the operating device. Thus, data packets are sent, like in a computer network, between the operating device or the data processing unit, respectively, and the central control unit. The central computer unit, in this case, a data processing unit. It sends, receives and processes data packets. This provides for an operation of the system in real time (see also https://de.wikipedia.org/w/index.php?title=Echtzeit&oldid=168410740 in this respect). The operating device, provided with a complete computer, thus becomes an “intelligent” operating device. It can preferably even be operated via its own graphic user interface. For example during the setup, the setup no longer needs to be made by a programmer, who accesses the central control unit. Now the setup can simply be made by the electromechanically trained technical staff.

Other advantageous further embodiments follow from the dependent patent claims.

An electrically operated operating device is also known from document DE 20 2008 013 025 U1. In the case of this development, however, which originates from the applicant, a direct connection of the operating device to the central control unit was in each case provided, as in the case of the above-mentioned prior art.

It is also pointed out that the operating device is referred to in this document as “pivoting clamping device”, which is not correct. However, because it is in fact a pivoting and not a clamping device. The difference between these two devices is that a pivoting device pivots an object between two positions with a fixedly defined torque, while a clamping device serves to clamp an object with a force, that can be set as needed. The person of skill in the art can recognize that the cited document is a pivoting device by the pivot arm illustrated in FIGS. 1 and 2.

It is further pointed out that even though the above-mentioned document (see paragraph [0024]) refers to a so-called absolute rotary position sensor or position sensor, respectively, this sensor, as the person of skill in the art knows, is simply a simple electronic component. It is installed in the motor hardware and only captures the absolute rotary angle position of the motor. Thus, it is not an independently operating data processing unit, which is provided to send, receive and process data packets, an independent computer.

An electrically operated operating device, more exactly a toggle lever clamping device, is also known from document DE 10 2013 005 484 B3. Like the above-mentioned prior art, it is always directly connected to a central control unit. The sensors for querying the position (reference numerals 8 and 9 therein) are obviously provided in the head piece in the case of this clamping device. Furthermore, it follows directly for the person of skill in the art that this clamping device does not have its own data processing unit. This is due to the fact that such a data processing unit does in fact make the use of such cost-intensive sensors superfluous in an advantageous manner.

The system for vehicle construction according to the disclosure including its advantageous further developments according to the dependent claims will be explained in more detail below based on the graphic illustration of a preferred exemplary embodiment.

### DRAWINGS

The drawings described herein are for illustrative purposes only of selected embodiments and not all possible implementations, and are not intended to limit the scope of the present disclosure.

FIG. 1 is a schematic view of a system according to the disclosure for vehicle construction with a central control unit and three operating devices; and

FIG. 2 is a partially section view of an operating device for the system according to FIG. 1.

### DETAILED DESCRIPTION

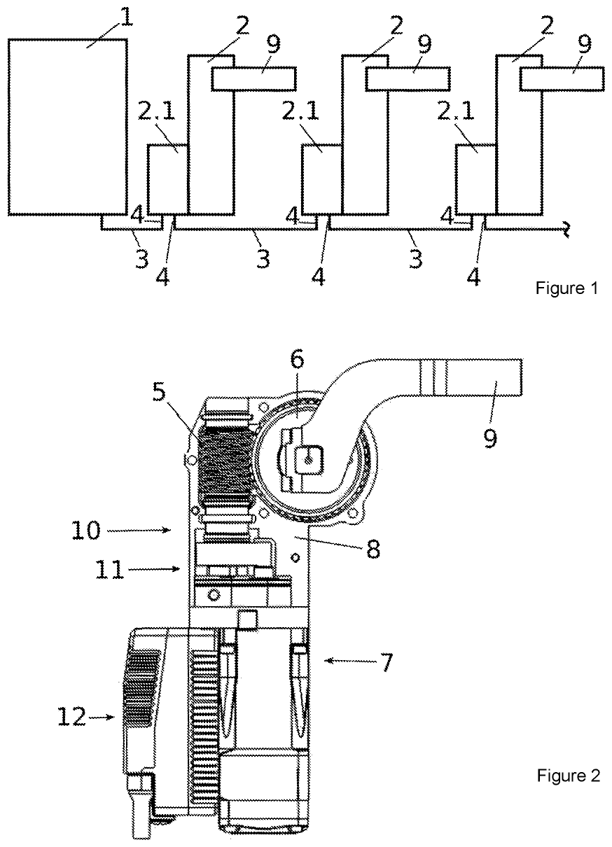

The system for vehicle construction illustrated in FIG. 1 includes a central control unit 1 and of at least two (three are illustrated) electrically operated operating devices 2. Each device has its own control unit 2.1 that controls movement in a manner that is known per se.

With reference to the mentioned operating device, with reference to FIG. 2 the operating device has a head piece 8 to rotatably support an operating element 9. Here, for example a clamping arm is shown. However, other head pieces including positioning, centering or pivoting characteristics, for example, are also possible. Thus, in particular, they include a positioning or centering mandrel or a pivot arm. The operating element 9 is operatively connected to an electric motor 7 arranged on the head piece 8, via a gear 10 arranged in the head piece 8. A torque is generated by the electric motor 7. Thus, according to a particularly preferred manner, the motor 7 is an alternating voltage servomotor. See https://de.wikipedia.org/w/index.php?title=Servomotor&oldid-163347715. Special electric motors, that allow for the control of the angular position of their motor shaft as well as of the rotational speed and acceleration, are identified as servomotors. The torque is transferred to the operating element 9 via the gear 10.

The head piece 8 is formed by two half shells. In FIG. 2, the electric motor 7 is shown in full side view. The head piece 8, in contrast, is shown in an installation situation. Here one of the two half shells is disassembled. Thus, the operating device can be seen in FIG. 2 with the open head piece 8. As can be seen, the dividing plane of the half shells runs parallel to the axis of rotation of the electric motor 7. Also provided in a particularly preferred manner, the bearings of the gear 10 are arranged in one or the dividing planes, respectively, of the head piece 8, that is formed of two half shells.

In a particularly advantageous manner, the operating device is embodied in a grease-lubricated and not oil-lubricated manner. Thus, the operating device is particularly small or at least as small as comparable pneumatic operating devices, respectively. The complete design in the case of a grease-lubricated operating device follows from the fact that the spaces for the components, that are to be lubricated, need to be kept small. Thus, the grease does not accumulate at a location, that does not need to be lubricated at all.

It is now essential for the system for vehicle body construction (see FIG. 1 again in this respect) that the control unit 2.1 of one of the two operating devices 2 is connected to the central control unit 1 via the control unit 2.1 of the other one of the two operating devices 2.

In the exemplary embodiment illustrated in FIG. 1, this proviso is thereby implemented, as can be seen, in that only a single operating device 2, which is identified as the first operating device, is connected to the central control unit 1. The one identified here as second operating one, is connected to the first one. The operating device identified here as third one, is connected to the second operating device. According to the disclosure, as already mentioned, the signal arriving from the central control unit 1 is thus looped through from one to the next operating device.

As already explained further above, control units 2.1 of the operating devices 2 are embodied as data processing units. The units 2.1 send, receive and process data packets. The control units 2.1 are thus embodied as full computers. Software is installed, that can also be identified as so-called firmware. See https://de.wikipedia.org/w/index.php?title=Firmware&oldid=166082869. For operating the operating device, “Firmware is understood to be software, that is embedded in electronic devices.” Thanks to these data processing units, it is possible in each motor position, that the control unit 2.1 is embodied to detect either a position, a power, a torque, a speed and/or a temperature of the electric motor 7.

Based on the use of data processing units, it is moreover, and in contrast to the above-mentioned DE 201 21 630 U1, also possible for the first time to embody the gear 10 between the electric motor 7 and the operating element 9 without an end position querying device or without a device for querying the end position, respectively.

As follows from FIGS. 1 and 2, the control unit 2.1 is accommodated in an auxiliary housing 12. The auxiliary housing 12 is arranged on the electric motor 7.

As illustrated in FIG. 1, an electrical cabling 3 formed of a plurality of cable bundles, runs in parallel, either between the central control unit 1 and a control unit 2.1 of an operating device 2 and/or between control units 2.1 of two operating devices 2 to transfer information, preferably LAN-based. In this respect, see https://de.wikipedia.org/w/index.php?title=Local_Area_Network&oldid=168795260. The power supply is preferably 24 Volt direct current. The operating device 2 in this case, and, if the electric motor 7 is preferably operated with alternating current, as mentioned above, has a converter for converting the direct current into alternating current. Thus, it is possible, due to this proviso, to connect the central control unit 1 and the operating devices 2 in the easiest way imaginable. This is because only one cable bundle needs to, in each case, be pulled from the central control unit 1 to the first operating device 2. A cable bundle is drawn from the first operating device to the second operating device 2. A cable bundle is drawn from the second operating device to the third operating device 2.

Furthermore, provided in a particularly preferred manner, the system according to the disclosure on or in particular the central control unit 1, respectively, the operating device 2 and the cabling 3, also called “hybrid cabling”, in particular “hybrid cabling with STO”, are embodied to fulfill the so-called stop category 1 (STO —“Safe Torque Off”) according to EN 60204, (see also https://de.wikipedia.org/w/index.php?title=Sicherheitsfunktion&oldid=166726912), and also DIN EN 61800-5-2. Thus, either the central control unit 1, the operating device 2 and/or the cabling 3 also have integrated or drive-integrated safety functions, respectively. Thus, risks originating from the running system are maximally reduced.

More concretely, in a particularly preferred manner, in order to realize safety functions, in particular a or the STO safety function, respectively, each data processing unit of the control units 2.1 and/or an additional data processing unit, which is additionally provided at each operating device 2, is optionally embodied with a software or that a software of this type is installed, respectively. This measure leads to a self-sufficiently functional safety function of each individual operating device 2. The integrated STO safety function can stop the electric motor 7 abruptly, namely completely independently of possible information coming from the central control unit 1. The safety function can furthermore be realized particularly well together with an operating device 2 comprising a self-locking gear, in particular a worm gear, that will be mentioned below.

In this context the central control unit 1 and/or the control units 2.1 is or are optionally embodied, respectively, for evaluating optionally possible error causes and/or process-relevant information of the operating device 2.

It is furthermore provided (see FIG. 1) that the control unit 2.1 of an operating device 2 has two electronic interfaces 4. The interfaces 4 are preferably identically embodied and which are preferably also attached to a or the auxiliary housing 12, respectively, that is arranged on the electric motor 7. The interfaces 4 connect to the central control unit 1 and a control unit 2.1 of another operating device 2, or connect to a control unit 2.1 of another operating device 2 and a control unit 2.1 of a third operating device 2.

As also already explained above, a graphic user interface for setting variables, such as either power, torque, angular position and/or speed of the operating device 2, is further provided in a particularly preferred manner. The graphic user interface is furthermore either stored as software (firmware) on the central control unit 1 and/or also as so-called “App”. (See also https://de.wikipedia.org/w/index.php?title=Anwendungssoftware&oldid=168914545) on a mobile computer. For example, a tablet computer or a smartphone, in a particularly preferred manner.

So that the operating device 2 remains in the respective position when the power supply is turned off (for whatever reason whatsoever), the operating device has a worm gear. The worm gear includes a worm shaft 5 and worm wheel 6 in order to realize a self-locking effect, see also https://de.wikipedia.org/w/index.php?title=Schneckengetriebe&oldid=166434662). Due to this worm gear, it is possible that the operating device 2 has an angle of rotation of 360°.

It is furthermore provided in a preferred manner that either an axis of rotation of the worm shaft 5 is embodied to run parallel and/or an axis of rotation of the worm wheel 6 is embodied to run perpendicular to an axis of rotation of the electric motor 7.

As suggested and illustrated in FIG. 2, a spur gear 11 is arranged between the electric motor 7 and the worm shaft 5.

Finally, it is provided in a preferable manner (but not illustrated separately) that the worm wheel 6 is connected to one of the operating element 9, respectively, or to the axis of rotation, respectively, by a spline.

As can be concluded from the above explanations, the system according to the disclosure for the vehicle construction belongs to a completely new generation of such systems. The new concept provides an operating comfort,that could not be reached to date. It starts with a very simple cabling 3 of the operating devices 2 and ends with the user-friendly settability of the total system via a graphic user interface, for example on a mobile end device, such as tablet computer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-12. (canceled)

13. A system for vehicle body construction, comprising a central control unit and at least two electrically operated operating devices, each device has its own control unit to control movement; and the control unit of one of the two operating devices is connected to the central control unit via the control unit of the other one of the two operating devices.

14. The system according to claim 13, wherein the control units of the operating devices are data processing units that send, receive and process data packets.

15. The system according to claim 13, further comprising an electrical cabling either between the central control unit and a control unit of an operating device and/or between control units of two operating devices to transfer information as well as supply power and preferably for integrated safety functions, in particular a STO safety function.

16. The system according to claim 13, wherein the control unit of an operating device has two electronic interfaces, the interfaces either connect to the central control unit and a control unit of another operating device, or connect to a control unit of another operating device and a control unit of a third operating device.

17. The system according to claim 13, further comprising a graphic user interface for setting variables, such as power, torque, angular position and/or speed of the operating device.

18. The system according to claim 17, wherein the graphic user interface is stored as software on the central control unit.

19. The system according to claim 13, wherein the operating device has a worm gear including a worm shaft and worm wheel in order to realize a self-locking effect.

20. The system according to claim 13, wherein
an electric motor operates the operating device, and
in each motor position, the control unit detects either a position, a power, a torque, a speed and/or a temperature of the electric motor.

21. The system according to claim 20, wherein the electric motor is an alternating voltage servomotor.

22. The system according to claim 13 wherein the operating device is embodied to be grease-lubricated.

23. The system according to claim 14 wherein in order to realize safety functions, in particular a STO safety function, each data processing unit of the control units and/or an additional data processing unit, that is additionally provided at each operating device, is optionally embodied with software.

24. The system according to claim 13 wherein the central control unit and/or the control units is or are optionally embodied, respectively, for evaluating optionally possible error causes and/or process-relevant information of the operating device.
